(19) United States
(12) Patent Application Publication
(10) Pub. No.: US 2018/0029921 A1
(43) Pub. Date: Feb. 1, 2018

(54) METHOD FOR PRODUCING GLASS PREFORM FOR OPTICAL FIBER

(71) Applicant: Shin-Etsu Chemical Co., Ltd., Tokyo (JP)

(72) Inventor: Yuhei URATA, Kashima (JP)

(21) Appl. No.: 15/659,998

(22) Filed: Jul. 26, 2017

(30) Foreign Application Priority Data
Jul. 29, 2016 (JP) 2016-150465

(51) Int. Cl. C03B 37/014; C03B 19/14; C03B 19/06

(52) U.S. Cl. CPC C03B 37/01446; C03B 19/06; C03B 19/1453

(57) ABSTRACT

Provided is a method for producing a glass preform for optical fiber which suppresses occurrences of cracks, coloring and foaming in a surface layer when sintering a glass fine particle deposit to allow a production yield to be improved. A method for producing a glass preform for optical fiber comprising the steps of: spraying glass fine particles containing silicon dioxide and germanium dioxide to a starting material moving upward while rotating to produce a glass fine particle deposit; and sintering the glass fine particle deposit while relatively varying a positional relationship between a heating source and the glass fine particle deposit in a sintering apparatus to produce a transparent glass preform, wherein a germanium dioxide reducing gas is contained in an atmosphere gas in the sintering apparatus.

### CROSS-REFERENCE TO RELATED APPLICATION

This non-provisional application claims priority under 35 U.S.C. §119(a) from Japanese Patent Application No. 2016-150465, filed on Jul. 29, 2016, the entire contents of which are incorporated herein by reference.

### BACKGROUND

### Technical Field

The present invention relates to a method for producing a glass preform for optical fiber which contributes to an improvement in a producing yield.

### BACKGROUND ART

In order to provide desired optical characteristics for an optical fiber, the refractive index difference between a region (core) through which light propagates and the periphery (clad) thereof is adjusted, or a shape is imparted to the refractive index distribution of the core. Various dopants are used to provide the relative refractive index difference A between the core and the clad. A method for adding germanium dioxide to silicon dioxide glass is generally known. In a gas phase method such as a VAD method (see, for example, JP 1-126236 A) which is one of optical fiber preform producing methods, a clad containing no dopant is formed so as to surround a core containing germanium dioxide as a dopant. The use of the VAD method can increase the molar concentration of the germanium dioxide in the silicon dioxide glass to 20 mol % or more.

In order to increase condensing power in an image fiber (see, for example, JP 4-6120 A) to obtain a bright image, it is preferable to increase the refractive index of a core per pixel to increase a numerical aperture (NA). The VAD method can be applied in order to produce a core portion for pixels of such an image fiber. As shown in FIG. 1, glass fine particles are sprayed to a rotating starting material 1 and deposited. The starting material 1 is grown in an axial direction while the starting material 1 is pulled up, to produce a columnar glass fine particle deposit 2. As a burner 3, for example, a multi-tube burner in which circular pipes are concentrically disposed is used. Oxygen and hydrogen are supplied to respective regions partitioned by the pipes, and burned to form an oxyhydrogen flame. A glass raw material such as silicon tetrachloride and a dopant source for increasing a refractive index such as germanium tetrachloride are supplied into the oxyhydrogen flame. Silicon dioxide and germanium dioxide are generated by a thermal oxidation reaction or a hydrolysis reaction, sprayed to the starting material 1, and deposited. The glass fine particle deposit thus produced is sintered in an inert gas atmosphere such as helium gas in a sintering apparatus to obtain a transparent glass rod.

### SUMMARY OF THE INVENTION

### Problems to be Solved by the Invention

If only an inert gas is used as a sintering atmosphere gas when a glass fine particle deposit in which the molar concentration of germanium dioxide in silicon dioxide is increased to 20 mol % or more is sintered to transparent glass, a glass layer containing a large amount of germanium dioxide is formed as a surface layer, which causes a problem that network cracks occur during cooling. There is also a problem that surface layer coloring (brown) and bubble in surface layer occur.

An object of the present invention is to provide a method for producing a glass preform for optical fiber which suppresses occurrences of cracks, coloring and bubble in a surface layer when sintering a glass fine particle deposit to allow a production yield to be improved.

### Means for Solving the Problems

(1) In the present invention, a method for producing a glass preform for optical fiber includes the steps of: spraying glass fine particles containing silicon dioxide and germanium dioxide to a starting material moving upward while rotating to produce a glass fine particle deposit; and sintering the glass fine particle deposit while relatively varying a positional relationship between a heating source and the glass fine particle deposit in a sintering apparatus to produce a transparent glass preform, wherein a germanium dioxide reducing gas is contained in an atmosphere gas in the sintering apparatus.

Thereby, the germanium dioxide in a surface layer of the transparent glass preform is reduced to a volatile substance, and the concentration of the germanium dioxide can be lowered by the volatilization of the volatile substance. Therefore, occurrence of cracks in the surface layer can be suppressed, and coloring in the surface layer, bubble in the surface layer, and bubble in a clad interface in the subsequent process can be suppressed. This allows a production yield to be improved.

(2) The germanium dioxide reducing gas is suitably carbon monoxide gas and/or chlorine gas.

(3) The surface of the produced transparent glass preform may be etched with hydrofluoric acid. This makes it possible to remove an adhering matter which causes surface layer coloring such as impurities adhering to the surface, particularly high-concentration germanium dioxide remaining on the surface, to allow a yield to be further improved.

### BRIEF DESCRIPTION OF THE DRAWINGS

FIG. 1 illustrates a method for producing a glass fine particle deposit; and

FIG. 2 shows an example of the refractive index distribution of a glass preform according to the producing method of the present invention.

### DETAILED DESCRIPTION OF THE EMBODIMENTS

Hereinafter, embodiments of the present invention will be described.

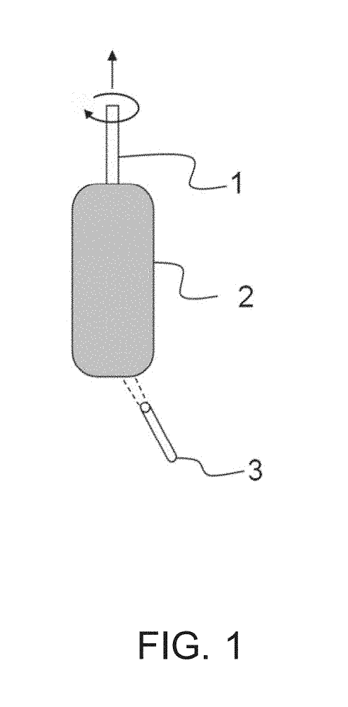

When doping of high-concentration germanium dioxide is required as in a high NA glass preform for pixel of an image fiber, a large amount of germanium tetrachloride is supplied together with silicon tetrachloride to a burner 3 shown in FIG. 1. Silicon dioxide and germanium dioxide produced by a hydrolysis reaction in an oxyhydrogen flame are sprayed to a starting material 1 to be pulled up while rotating, and deposited and grown in an axial direction, so that a porous glass fine particle deposit 2 is produced. At this time, a high-temperature portion of a burner flame is in contact with the vicinity of the center of the glass fine particle deposit 2, so that most of deposited soot is in a solid solution state of the silicon dioxide and germanium dioxide. On the other hand, most of soot made of only germanium dioxide which does not form a solid solution with silicon dioxide is deposited near the outer surface. The germanium dioxide deposited on the outer surface is not adequately incorporated into the glass structure of the silicon dioxide in a transparent vitrification treatment but remains in a state of being separated from the silicon dioxide. Such locally remaining high-concentration germanium dioxide causes occurrences of surface layer cracks, surface layer coloring, and bubble in surface layer.

Then, a germanium dioxide reducing gas is contained in an atmosphere gas during transparent vitrification by sintering. Thereby, the germanium dioxide is reduced to a volatile substance, and the concentration of the germanium dioxide can be lowered by the volatilization of the volatile substance.

For example, carbon monoxide gas is added to an atmosphere gas to produce the following reaction, so that germanium dioxide can be reduced and removed as volatile germanium monoxide.

GeO₂+CO→GeO+CO₂

Chlorine gas is added to an atmosphere gas to produce the following reaction, so that germanium dioxide can be reduced and removed as volatile germanium tetrachloride.

GeO₂+2Cl₂→GeCl₄+O₂

These reactions are gas-solid reactions which proceed on the surface of the soot (glass fine particles) forming the glass fine particle deposit. Therefore, soot (glass fine particles) mainly containing germanium dioxide and forming no solid solution with silicon dioxide has a faster reaction rate than that of soot (glass fine particles) in which germanium dioxide forms a solid solution with silicon dioxide and is incorporated into a glass structure, which effectively reduces the germanium dioxide. For this reason, in a core rod produced by performing the treatment, the concentration of the germanium dioxide localized unevenly in the vicinity of the outer surface of a preform is lowered, so that occurrences of surface layer cracks, surface layer coloring, and bubble in surface layer and the like are suppressed, to allow a producing yield to be improved.

The surface of the transparent glass preform produced by the method for producing a glass preform for optical fiber of the present invention is etched with hydrofluoric acid, which makes it possible to remove an adhering matter which causes surface layer coloring such as impurities adhering to the surface, particularly the high-concentration germanium dioxide remaining on the surface. This makes it possible to further improve the yield.

It should be noted that the present invention is not limited to the above embodiment. The above embodiment is just an example, and any examples that have substantially the same configuration and exhibit the same functions and effects as the technical concept described in claims according to the present invention are included in the technical scope of the present invention.

### EXAMPLES

### Comparative Example 1

Silicon tetrachloride and germanium tetrachloride (glass raw materials) vaporized were respectively fed at flow rates of 2.7 g/min and 1 g/min together with oxygen flowing at a rate of 0.2 L/min to a center tube of a four-tube burner. Hydrogen was fed at flow rate of 7.3 L/min to an outer adjacent port. Argon was fed at flow rate of 1.7 L/min to the outer port of the outer adjacent port. Oxygen was fed at flow rate of 15 L/min to the outermost port. The glass raw materials were hydrolyzed in an oxyhydrogen flame, thereby producing glass fine particles (soot). The produced soot was deposited on a starting material to be pulled up while rotating, to produce a glass fine particle deposit having a length of 600 mm.

The produced glass fine particle deposit was suspended in a sintering furnace tube. A heater of the sintering furnace was then heated to 1430° C., and the position of the glass fine particle deposit was slowly lowered. The glass fine particle deposit was passed through a heater section so that heating is sequentially performed from the lower part of the glass fine particle deposit to the upper part thereof, to subject the glass fine particle deposit to a transparent vitrification treatment. During the treatment, only helium gas was flowed at a flow rate of 20 L/min into the furnace tube.

In most of the glass preforms completely subjected to transparent vitrification, cracks occurred in the surface of the glass preform during cooling, which caused the glass preform to be unusable. Even in the glass preforms having no cracks, brown coloring was observed on the surfaces of all preforms, whereas bubble was observed in the surface layers of some of the glass preforms.

### Example 1

A glass fine particle deposit of 600 mm was produced under the same gas conditions using a four-tube burner in the same manner as in Comparative Example 1. The produced glass fine particle deposit was suspended in a sintering furnace tube. A heater of the sintering furnace was then heated to 1430° C., and the position of the glass fine particle deposit was slowly lowered. The glass fine particle deposit was passed through a heater section so that heating is sequentially performed from the lower part of the glass fine particle deposit to the upper part thereof, to subject the glass fine particle deposit to a transparent vitrification treatment. During the treatment, in addition to helium gas at flow rate of 20 L/min, carbon monoxide gas was flowed at flow rate of 0.1 L/min into the furnace tube.

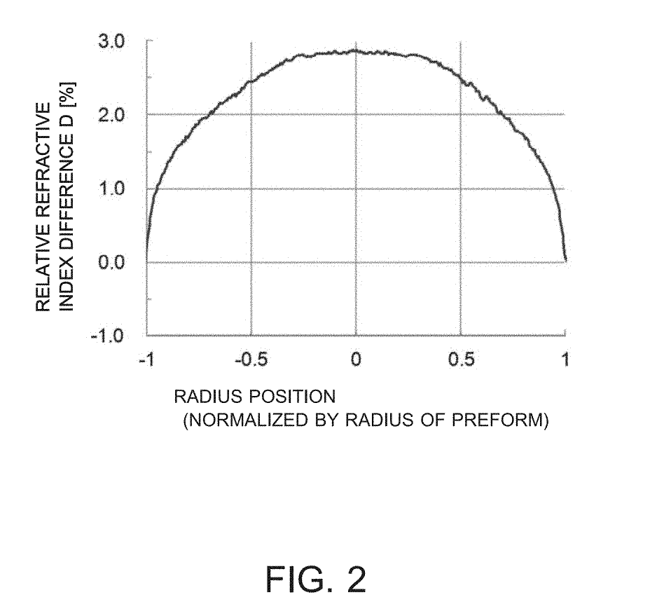

No surface cracks occurred in a glass preform even after cooling after transparent vitrification, and no surface coloring/bubble in surface layer was observed. FIG. 2 shows the radial refractive index distribution of the transparent glass preform in a radial direction. This shows that the refractive index is lowered also in the vicinity of the outer periphery, which provides the removal of germanium dioxide.

### Example 2

A glass fine particle deposit of 600 mm was produced under the same gas conditions using a four-tube burner in the same manner as in Comparative Example 1. The produced glass fine particle deposit was suspended in a sintering furnace tube. A heater of the sintering furnace was then heated to 1430° C., and the position of the glass fine particle deposit was slowly lowered. The glass fine particle deposit was passed through a heater section so that heating is sequentially performed from the lower part of the glass fine particle deposit to the upper part thereof, to subject the glass fine particle deposit to a transparent vitrification treatment. During the treatment, in addition to helium gas at flow rate of 20 L/min, carbon monoxide gas was flowed at flow rate of 0.1 L/min into the furnace tube.

A transparent glass preform after sintering was cooled to room temperature, but no surface cracks occurred.

The transparent glass preform was immersed in a hydrofluoric acid aqueous solution to etch the surface of the transparent glass preform at an average thickness of 0.2 mm, thereby removing impurities adhering to the surface. At this time, if a nonuniform portion of germanium dioxide (such as a locally high-concentration inplane portion) is present in the surface of the glass preform, different solubility in hydrofluoric acid is caused to roughen the surface. However, such surface roughness did not occur. No surface coloring/bubble in surface layer and the like was observed. The transparent glass preform could be drawn by a glass lathe without any problem.

### Example 3

A glass fine particle deposit of 600 mm was produced under the same gas conditions using a four-tube burner in the same manner as in Comparative Example 1. The produced glass fine particle deposit was suspended in a sintering furnace tube. A heater of the sintering furnace was then heated to 1430° C., and the position of the glass fine particle deposit was slowly lowered. The glass fine particle deposit was passed through a heater section so that heating is sequentially performed from the lower part of the glass fine particle deposit to the upper part thereof, to subject the glass fine particle deposit to a transparent vitrification treatment. During the treatment, in addition to helium gas at flow rate of 20 L/min, chlorine gas was flowed at flow rate of 0.1 L/min into the furnace tube.

A transparent glass preform after sintering was cooled to room temperature, but no surface cracks occurred. When this transparent glass preform was stretched by a glass lathe, it took time to adjust the thermal power of the glass lathe because of the low viscosity of the glass, and bubbling occurred inside the glass in about 10% of the preforms. This is considered to be due to chlorine taken into the glass during sintering.

The above experiment results show that the method for producing the glass preform for optical fiber of the present invention suppresses occurrences of cracks in the surface layer, coloring and bubbling when sintering the glass fine particle deposit, to allow the production yield of the glass preform to be improved. Such an effect can be obtained when any of the carbon monoxide gas and the chlorine gas is added as the atmosphere gas in the sintering apparatus. However, it is thought that the carbon monoxide gas is more suitable considering the yield after stretching processing.

What is claimed is:

1. A method for producing a glass preform for optical fiber comprising the steps of:
spraying glass fine particles containing silicon dioxide and germanium dioxide to a starting material moving upward while rotating to produce a glass fine particle deposit; and
sintering the glass fine particle deposit while relatively varying a positional relationship between a heating source and the glass fine particle deposit in a sintering apparatus to produce a transparent glass preform,
wherein a germanium dioxide reducing gas is contained in an atmosphere gas in the sintering apparatus.

2. The method according to claim 1, wherein the germanium dioxide reducing gas is carbon monoxide gas and/or chlorine gas.

3. The method according to claim 1, wherein a surface of the produced transparent glass preform is etched with hydrofluoric acid.
